(19) United States
(12) Patent Application Publication
(10) Pub. No.: US 2013/0044341 A1
(43) Pub. Date: Feb. 21, 2013

(54) IMAGE FORMING APPARATUS AND IMAGE FORMING SYSTEM

(71) Applicant: Satoshi UCHINO, Toyokawa-shi (JP)

(72) Inventor: Satoshi UCHINO, Toyokawa-shi (JP)

(73) Assignee: Konica Minolta Business Technologies, Inc., Chiyoda-ku (JP)

(21) Appl. No.: 13/571,469

(22) Filed: Aug. 10, 2012

(30) Foreign Application Priority Data
Aug. 19, 2011 (JP) 2011-179395

(51) Int. Cl. G06K 15/02

(52) U.S. Cl. 358/1.13

(57) ABSTRACT

The image forming apparatus includes an operation input unit having a first touch screen, a reception unit configured to receive information regarding an operation target file from a mobile terminal in accordance with a drag-and-drop operation across the first touch screen and a second touch screen provided in the mobile terminal, and an operation control unit configured to execute an action regarding the operation target file, based on the information regarding the operation target file received by the reception unit.

This application is based on Japanese Patent Application No. 2011-179395 filed on Aug. 19, 2011, the contents of which are hereby incorporated by reference.

### BACKGROUND OF THE INVENTION

1. Technical Field

The present invention relates to an image forming apparatus and a technique related thereto.

2. Related Art

In image forming apparatuses such as MFPs (Multi-Functional Peripherals), a touch screen or the like is provided in an operation display unit, and operation input from a user is received using the touch screen or the like. In operation input with a touch screen, buttons displayed in a window also function as input buttons, and a display output portion and an input reception portion correspond directly to each other. Operation input with a touch screen thus has the advantage of, for example, being able to implement operations that are intuitive and very easy to understand.

Japanese Patent Application Laid-open No. 2010-250463 (JP 2010-250463A) discloses a technique for implementing drag-and-drop operations using two touch screens provided within a single device (information processing apparatus).

Incidentally, it is preferable for image forming apparatuses to operate in coordination with other devices, particularly personal digital assistants (also referred to as mobile terminals), as well as operating alone.

Note that the technique disclosed in the above JP 2010-250463A is intended to implement drag-and-drop operations using two touch screens provided within a single device (information processing apparatus), and is not intended to implement drag-and-drop operations across different devices.

### SUMMARY OF THE INVENTION

It is an object of the present invention to provide an image forming apparatus capable of improving coordination with a mobile terminal, and a technique related thereto.

According to a first aspect of the present invention, the image forming apparatus includes an operation input unit having a first touch screen, a reception unit configured to receive information regarding an operation target file from a mobile terminal in accordance with a drag-and-drop operation across the first touch screen and a second touch screen provided in the mobile terminal, and an operation control unit configured to execute an action regarding the operation target file, based on the information regarding the operation target file received by the reception unit.

According to a second aspect of the present invention, an image forming system includes an image forming apparatus, and a mobile terminal capable of coordination with the image forming apparatus. The image forming apparatus includes an operation input unit having a first touch screen, a reception unit configured to receive information regarding an operation target file from a mobile terminal in accordance with a drag-and-drop operation across the first touch screen and a second touch screen provided in the mobile terminal, and an operation control unit configured to execute an action regarding the operation target file, based on the information regarding the operation target file received by the reception unit.

According to a third aspect of the present invention, an image forming system includes an image forming apparatus, and a mobile terminal capable of coordination with the image forming apparatus. The image forming apparatus includes an operation input unit having a first touch screen, and a transmission unit that is configured to transmit information regarding an operation target file to the mobile terminal in accordance with a drag-and-drop operation across the first touch screen and a second touch screen provided in the mobile terminal. The mobile terminal includes a reception unit configured to receive the information regarding the operation target file from the transmission unit of the image forming apparatus, and an operation control unit configured to execute an action regarding the operation target file, based on the information regarding the operation target file received by the reception unit.

These and other objects, features, aspects and advantages of the present invention will become more apparent from the following detailed description of the present invention when taken in conjunction with the accompanying drawings. These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic diagram showing an image forming system according to a first embodiment.

FIG. 2 is a functional block diagram showing a schematic configuration of an MFP.

FIG. 3 is a functional block diagram showing a schematic configuration of a mobile terminal.

FIG. 4 shows operations performed in the image forming system according to the first embodiment.

FIG. 5 shows a state in which a mobile terminal is placed beside an operation panel unit.

FIG. 6 shows a coordination preparation operation.

FIG. 7 shows both touch screens when starting a coordinated operation.

FIG. 8 shows both touch screens immediately after a drag operation is started.

FIG. 9 shows a state in which an icon has been moved to the operation panel side.

FIG. 10 shows a drop operation.

FIG. 11 shows the overall drag-and-drop operation.

FIG. 12 shows an advanced settings window displayed immediately after the drop operation.

FIG. 13 shows a drag-and-drop operation to a “FAX” button.

FIG. 14 shows an advanced settings window displayed immediately after the drop operation.

FIG. 15 shows a drag-and-drop operation to a “BOX” button.

FIG. 16 shows an advanced settings window displayed immediately after the drop operation.

FIG. 17 shows a file transfer operation from the MFP to the mobile terminal.

FIG. 18 shows the file transfer operation from the MFP to the mobile terminal.

FIG. 19 shows a data table in which execution histories are stored.

FIG. 20 shows an advanced settings window including a “Previous Settings” button.

FIG. 21 shows operations according to a third embodiment.

### DETAILED DESCRIPTION OF THE PREFERRED EMBODIMENTS

Hereinafter, embodiments of the present invention will be described with reference to the drawings.

### 1. First Embodiment

1-1. System Outline

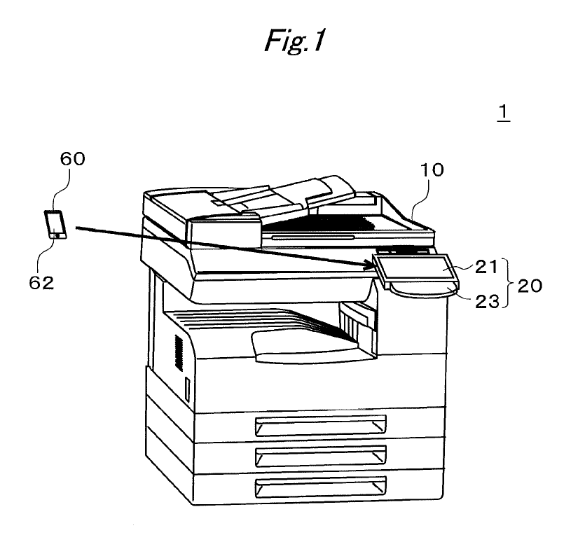

FIG. 1 is a schematic diagram showing an image forming system 1 according to the present embodiment.

As shown in FIG. 1, the image forming system 1 includes an image forming apparatus 10 and a personal digital assistant (also referred to as a “mobile terminal”) 60. Here, an MFP (Multi-Functional Peripheral) is given as an example of the image forming apparatus.

The MFP (image forming apparatus) 10 and the mobile terminal 60 are capable of bidirectional wireless communication. For example, wireless communication between the MFP 10 and the mobile terminal 60 can be performed by, for example, communication via a wireless LAN or communication based on various types of standards such as Bluetooth.

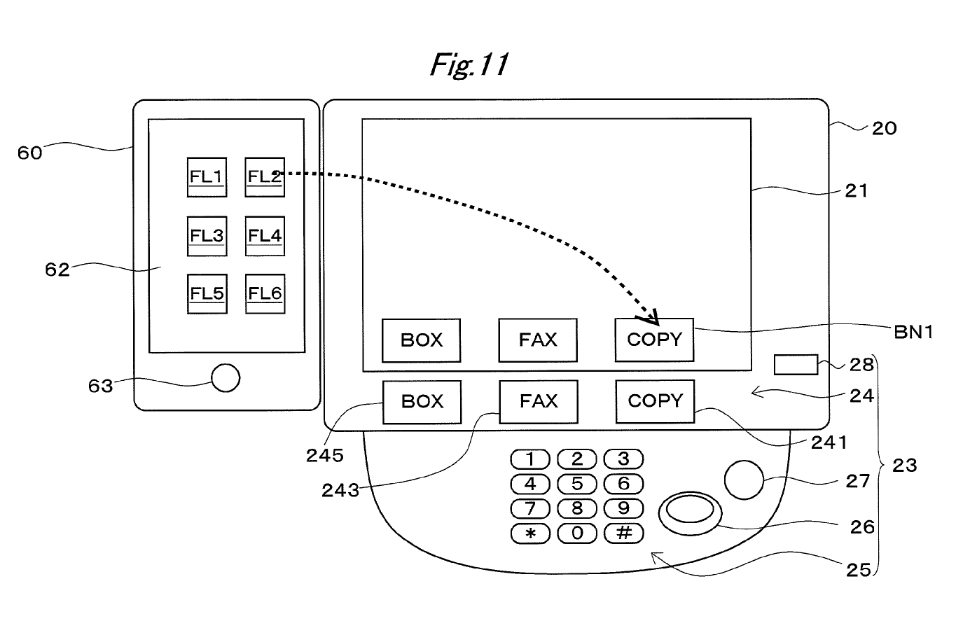

As will be described later, using the wireless communication enables the MFP 10 and the mobile terminal 60 to exchange various types of information therebetween and implement drag-and-drop operations across a touch screen 21 of the MFP 10 and a touch screen 62 provided in the mobile terminal 60 (see FIG. 11, for example). In response to such a drag-and-drop operation, the MFP 10 receives information (e.g., file data) regarding an operation target file from the mobile terminal 60, and executes an action regarding the operation target file (e.g., a print output operation, a FAX transmission operation, or a BOX storage operation) based on the information regarding the operation target file. In this way, the mobile terminal 60 is a terminal capable of coordination with the MFP 10.

1-2. Configuration of MFP

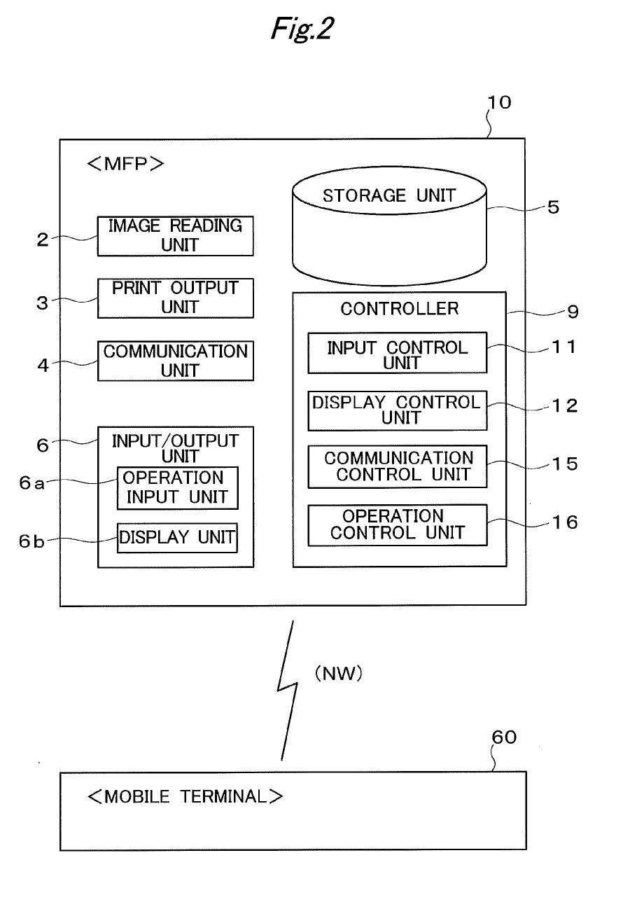

FIG. 2 is a functional block diagram showing a schematic configuration of the MFP 10.

The MFP 10 is an apparatus having various functions such as a scan function, a copy function, a facsimile function, and a box storage function (also referred to as a “Multi-Functional Peripheral”). Specifically, the MFP 10 includes an image reading unit 2, a print output unit 3, a communication unit 4, a storage unit 5, an input/output unit 6, a controller 9, and the like as shown in the functional block diagram of FIG. 2, and implements various types of functions by operating these units in combination.

The image reading unit 2 is a processing unit that optically reads (i.e., scans) an original document placed at a predetermined position on the MFP 10 and generates image data of the original document (also referred to as an “original document image” or a “scanned image”). The image reading unit 2 is also called a scan unit.

The print output unit 3 is an output unit that prints out an image on various types of media such as paper, based on data regarding an object to be printed.

The communication unit 4 is a processing unit capable of facsimile communication via a public network or the like. The communication unit 4 is also capable of network communication via a network NW. In the network communication, various types of protocols such as TCP/IP (Transmission Control Protocol/Internet Protocol) are used. Using such network communication enables the MFP 10 to exchange various types of data with a desired party (e.g., the mobile terminal 60 or other computers).

In particular, the communication unit 4 is capable of wireless communication with the mobile terminal 60, and more specifically, is capable of wireless communication via a wireless LAN. The communication unit 4 is also capable of wireless communication based on various types of standards such as Bluetooth (registered trademark).

The storage unit 5 is configured by a storage device such as a hard disk drive (HDD). The storage unit 5 stores data regarding a print job or the like as well as various types of history information or the like.

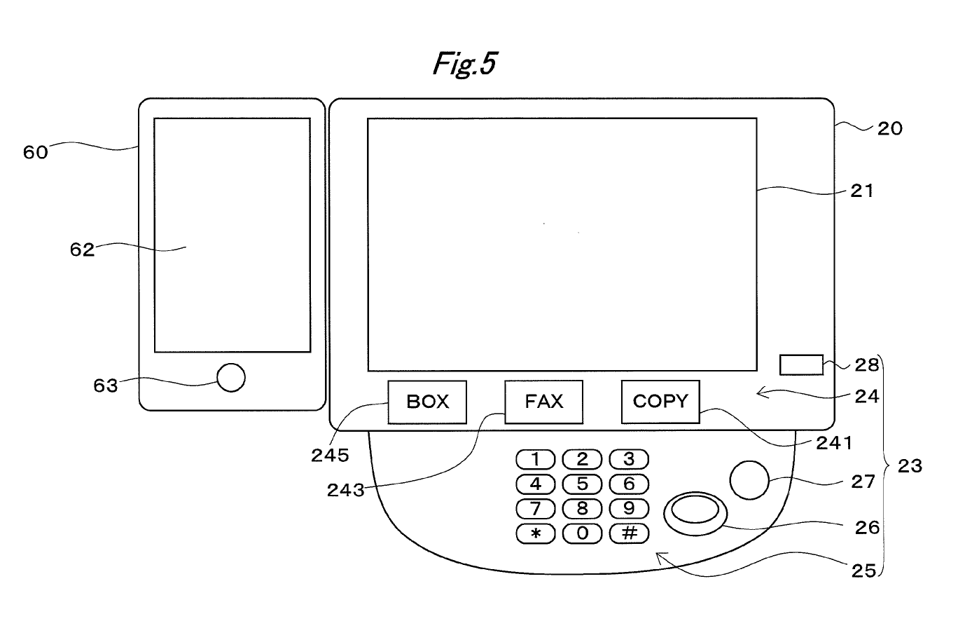

The input/output unit 6 includes an operation input unit 6a that receives input to the MFP 10, and a display unit 6b that displays and outputs various types of information. In the MFP 10, an operation panel unit 20 (see FIGS. 1 and 5) is provided as the input/output unit 6.

The operation panel unit 20 includes the touch screen 21 in which a piezoelectric sensor or the like is embedded in a liquid crystal display panel. The touch screen 21 functions as part of the display unit 6b and also functions as part of the operation input unit 6a.

The operation panel unit 20 further includes various types of hardware buttons (keys) 23 (see FIG. 5) that function as the operation input unit 6a. Specifically, the hardware buttons 23 include action execution buttons 24, a numeric keypad 25, a start button 26, a stop button 27, and a reset button 28. Here, three action execution buttons 24 (namely, 241, 243, and 245) for receiving instructions to execute various types of actions (in other words, various types of functions) are provided as the action execution buttons 24. Specifically, a hardware button (“copy button”) 241 for receiving an instruction to execute a copy function, a hardware button (“FAX button”) 243 for receiving an instruction to execute a facsimile communication function, and a hardware button (“BOX button”) 245 for receiving an instruction to execute a box storage function are provided as the action execution buttons 24.

The controller 9 is a control device that is built in the MFP 10 and performs overall control of the MFP 10. The controller 9 is configured as a computer system that includes, for example, a CPU and various types of semiconductor memories (RAM and ROM). The controller 9 executes, in the CPU, a predetermined software program (hereinafter, also referred to simply as a “program”) PG1 stored in the ROM (e.g., EEPROM), thereby implementing various types of processing units. Note that the program PG1 may be installed in the MFP 10 via, for example, a portable recording medium such as a USB memory, or the network NW.

Specifically, as shown in FIG. 2, the controller 9 implements various types of processing units including an input control unit 11, a display control unit 12, a communication control unit 15, and an operation control unit 16.

The input control unit 11 is a processing unit that receives input (operation input) to the MFP 10 in cooperation with the operation input unit 6a (e.g., operation panel unit 20).

The display control unit 12 is a processing unit that controls, for example, a display output operation performed by the display unit 6b (operation panel unit 20 or the like).

The communication control unit 15 is a processing unit that performs communication with external devices (a transmission destination device in facsimile communication, the mobile terminal 60, and the like) in cooperation with the communication unit 4.

The operation control unit 16 is a processing unit that controls operations or the like regarding various types of jobs (e.g., a copy job, a print output job, a facsimile communication job, or a box storage job).

1-3. Configuration of Mobile Terminal 60

The mobile terminal 60 is configured as a mobile computer system. The mobile terminal 60 includes the touch screen 62 and a hardware button 63 and is capable of receiving various types of operation input from a user (see FIGS. 1 and 5).

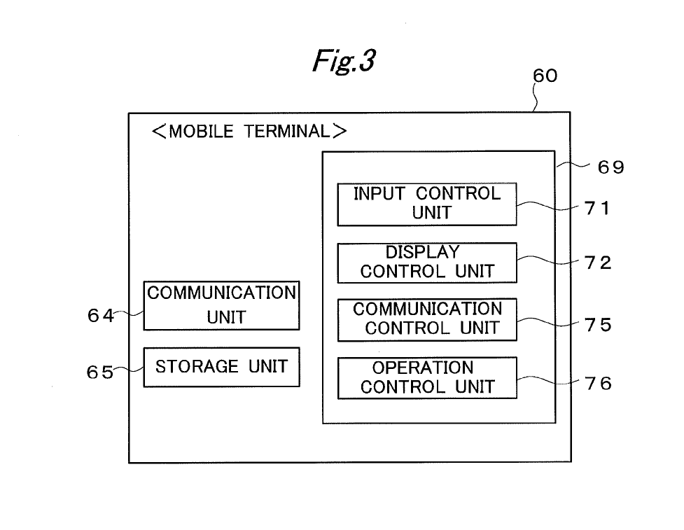

FIG. 3 is a functional block diagram showing a schematic configuration of the mobile terminal 60. As shown in FIG. 3, the mobile terminal 60 includes a communication unit 64, a storage unit 65, a controller 69, and the like.

The communication unit 64 is capable of network communication. Using the network communication enables the mobile terminal 60 to exchange various types of data with a desired party (e.g., MFP 10). In particular, the mobile terminal 60 is capable of wireless communication with the MFP 10, and more specifically, capable of communication via a wireless LAN. The communication unit 64 is also capable of wireless communication based on various types of standards such as Bluetooth.

The storage unit 65 is configured by a storage device such as a nonvolatile semiconductor memory. The storage unit 5 stores various types of data files and the like.

The controller 69 is configured as a computer system that includes a CPU, various types of semiconductor memories, and the like.

The controller 69 executes, in the CPU, a program stored in the storage unit 65, thereby implementing various types of processing units.

More specifically, a predetermined operating system (OS) such as Android (registered trademark) is installed in the mobile terminal 60, and a plurality of application software programs (also referred to as “application programs” or the like) can be executed on this OS. These application programs include an application software program PG2 for achieving coordination with the MFP 10, for example.

The mobile terminal 60 can achieve coordination with the MFP 10 by executing the application program PG2 and exchanging various types of information with the MFP 10. As shown in FIG. 3, the controller 69 can implement various types of processing units including an input control unit 71, a display control unit 72, a communication control unit 75, and an operation control unit 76, by executing the application program PG2.

The input control unit 71 is a processing unit that receives input (operation input) to the mobile terminal 60 in cooperation with an operation input unit (e.g., touch screen 62 and button 63).

The display control unit 72 is a processing unit that controls, for example, a display output operation performed by a display unit (e.g., touch screen 62).

The communication control unit 75 is a processing unit that performs communication with external devices (e.g., MPF 10) in cooperation with the communication unit 64.

The operation control unit 76 is a processing unit that controls operations regarding various types of jobs (e.g., a folder storage job).

1-4. Operation

Next, coordinated operation between the mobile terminal 60 and the MFP 10 will be described. The following describes operation in which a data file (hereinafter also referred to simply as a “file”) within the mobile terminal 60 is transmitted to the MFP 10 and various types of actions are executed based on the data file. As will be described later, an action regarding an operation target file (here, one of a copy operation, a facsimile transmission operation, and a box storage operation) is executed in accordance with a drag-and-drop operation across the touch screen 21 of the operation panel unit 20 and the touch screen 62 of the mobile terminal 60 (see FIG. 11, for example).

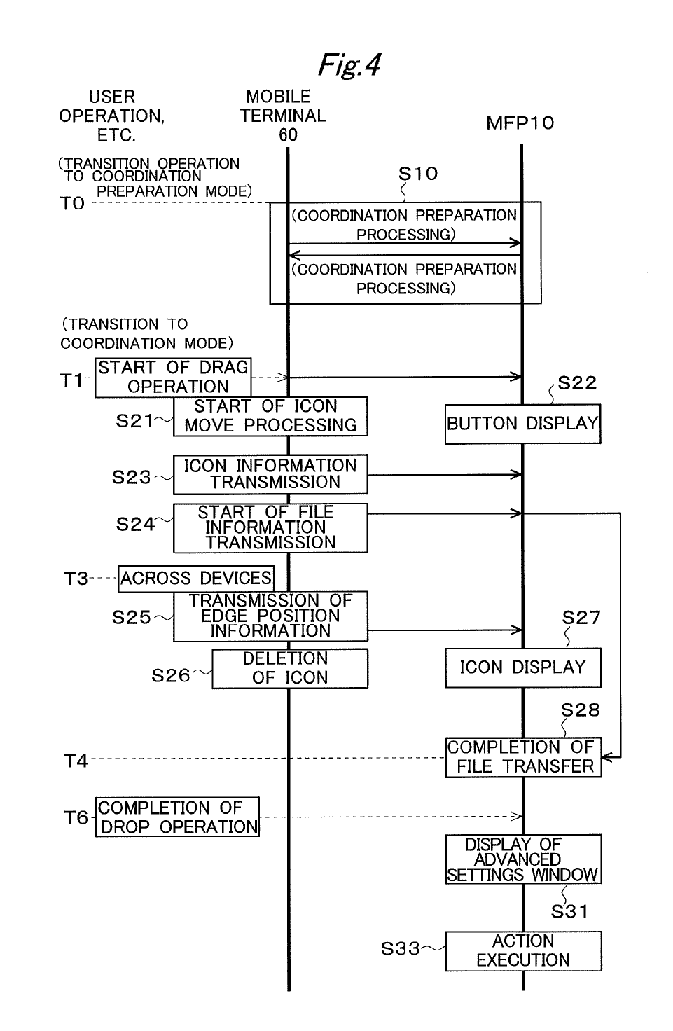

FIG. 4 shows these operations.

As shown in FIG. 4, first, a user UA, through a predetermined operation, causes both the mobile terminal 60 and the MFP 10 to transition to a “coordination preparation mode” and start a coordination preparation operation (time T0).

The user UA also brings the mobile terminal 60 closer to the operation panel unit 20 of the MFP 10 (see FIG. 1) and holds the mobile terminal 60 with the left hand so that a right-side face portion of the mobile terminal 60 and a left-side face portion of the operation panel unit 20 are in contact with each other as shown in FIG. 5.

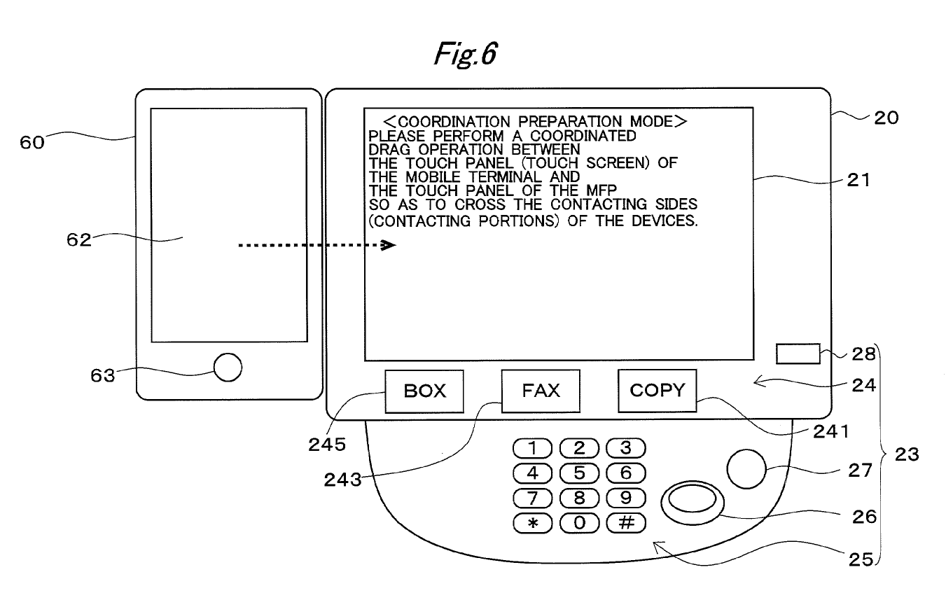

At this time, as shown in FIG. 6, the content of an operation instruction to a user for coordination preparation is displayed in the operation panel unit 20. Specifically, the text “Please perform a coordinated drag operation between the touch panel (touch screen) of the mobile terminal and the touch panel of the MFP so as to cross the contacting sides (contacting portions) of the devices.” is displayed.

The user UA performs a drag operation based on this display content. Specifically, for example, the user UA first touches an appropriate position (e.g., center) on the touch screen 62 of the mobile terminal 60 with a finger (e.g., forefinger) of the right hand. Then, the user UA starts a drag operation by sliding the finger to the right in the horizontal direction on the touch screen 62 while keeping the finger in contact with the touch screen 62. The user UA further continues the drag operation to the right in the horizontal direction even after reaching a right-side frame portion of the touch screen 62 and a left-side frame portion of the touch screen 21, then touches the vicinity of a left-side edge portion of the touch screen 21 with the finger, and continues the drag operation for a while on the touch screen 21 before ending the drag operation (see the bold dotted line in FIG. 6).

Through this, the MFP 10 can recognize that the mobile terminal 60 is positioned along the left side of the touch screen 21, which has a substantially rectangular shape (in other words, the mobile terminal 60 is in contact with the left side of the touch screen 21). The MFP 10 can also recognize a relative positional relationship between the mobile terminal 60 and the operation panel unit 20 in a direction along the contact side (the left side of the touch screen 21).

Similarly, the mobile terminal 60 can recognize that the operation panel unit 20 of the MFP 10 is positioned along the right side of the touch screen 62, which has a substantially rectangular shape (in other words, the operation panel unit 20 of the MFP 10 is in contact with the right side of the touch screen 62). The mobile terminal 60 can also recognize a relative positional relationship between the mobile terminal 60 and the operation panel unit 20 in a direction along the contact side (the right side of the touch screen 62).

The MFP 10 and the mobile terminal 60 mutually transmit and receive information regarding the recognized drag operation.

When such a coordination preparation operation has been completed, the MFP 10 and the mobile terminal 60 both automatically transition to a “coordination mode”. As a result, the MFP 10 transitions to a state of being able to receive an execution instruction based on a drag-and-drop operation from the mobile terminal 60 to the MFP 10. Likewise, the mobile terminal 60 also transitions to a state of being able to receive an execution instruction based on a drag-and-drop operation from the MFP 10 to the mobile terminal 60.

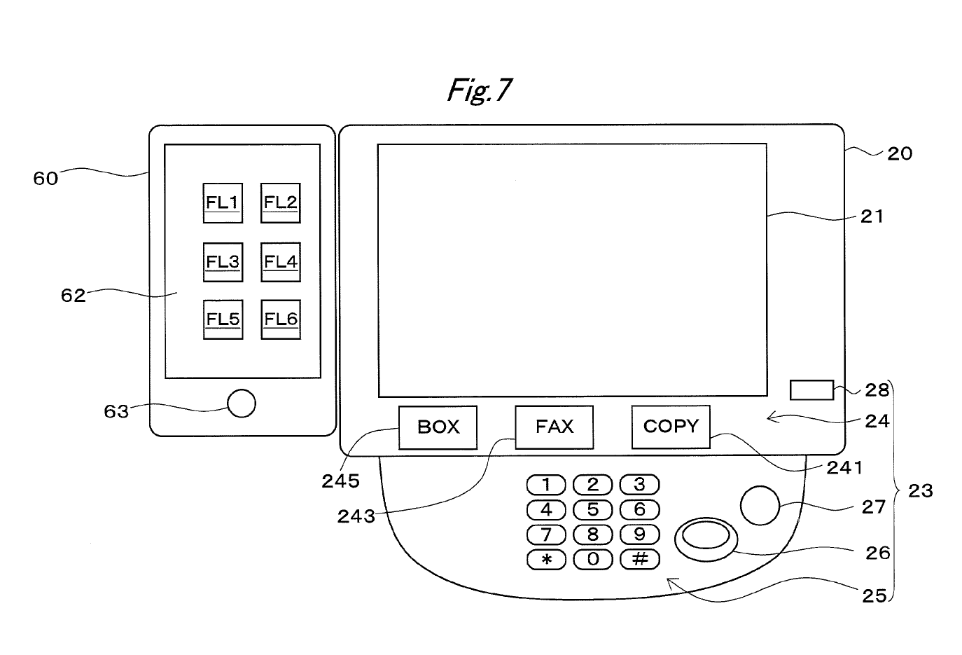

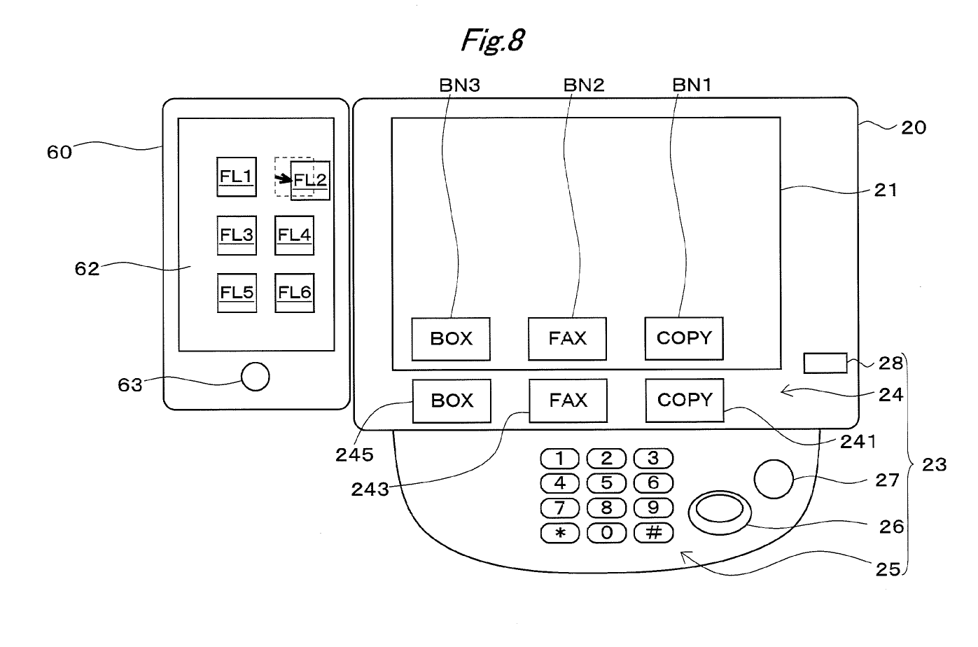

Thereafter, the user UA selects an operation target file (e.g., file FL2) from a plurality of files (in FIG. 7, six files FL1 to FL6) displayed on the touch screen 62 under control of the application program PG2 as shown in FIG. 7. The user UA then performs an operation of dragging and dropping the operation target file (specifically, an icon of the file) (see FIG. 11, and more specifically, see FIGS. 8 to 10) and gives an instruction to execute an action on the operation target file (e.g., a print output operation).

Here, at the time of switching to the “coordination mode” (in other words, at a time before the operation of dragging the operation target file is started), nothing is displayed on the touch screen 21 as shown in FIG. 7. Thus, even if the user recognizes that it is possible to given an action execution instruction by dragging and dropping a file, the drop destination is not clear.

In view of this, in the present embodiment, “instruction receiving buttons” (BN1 to BN3) (for receiving instructions to execute actions) are displayed on the touch screen 21, as shown in FIG. 8, at a predetermined point in time after the operation of dragging the operation target file is started (in FIG. 8, at a point in time immediately after the drag operation is started).

These instruction receiving buttons BN1 to BN3 are buttons realized by software and displayed on the touch screen 21 (so-called software buttons). The instruction receiving buttons BN1 to BN3 are provided as target areas for the drop operation of a drag-and-drop operation, i.e., a so-called destination of dropping (drop destination area). Note that although the instruction receiving buttons BN1 to BN3 are represented as “buttons”, they do not necessarily have to have a function of responding to a pressing operation by the user, and it is sufficient for them to function as a drop destination area.

The instruction receiving buttons BN1, BN2, and BN3 are respectively provided in correspondence with hardware buttons 241, 243, and 245.

Specifically, the instruction receiving buttons BN1, BN2, and BN3 are respectively provided at positions inwardly of (specifically, immediately above) the hardware buttons 241, 243, and 245 provided in the periphery of the touch screen 21 (specifically, below the lower side of the touch screen 21).

The instruction receiving buttons BN1, BN2, and BN3 are buttons for receiving instructions to execute actions that realize the functions corresponding to the hardware buttons 241, 243, and 245.

Specifically, the instruction receiving button (“COPY” button) BN1 is a button for receiving an instruction to execute an action AC1. The action AC1 realizes a function corresponding to the function (“copy (copy and print output)”) of the hardware button 241 (specifically, a function of printing and outputting the operation target file).

The instruction receiving button (“FAX” button) BN2 is a button for receiving an instruction to execute an action AC2. The action AC2 realizes a function corresponding to the function (“facsimile transmission”) of the hardware button 243 (specifically, a function of transmitting the operation target file by facsimile).

The instruction receiving button (“BOX” button) BN3 is a button for receiving an instruction to execute an action AC3. The action AC3 realizes a function corresponding to the function (“box processing”) of the hardware button 245 (specifically, a box storage function of storing the operation target file in a box).

In the case where the user UA recognizes that it is possible to give an action execution instruction by the operation of dragging and dropping a file, if the buttons BN1, BN2, and BN3 are displayed on the touch screen 21, these buttons BN1, BN2, and BN3 can be appropriately recognized as target areas for the drop operation. In other words, the user UA can relatively easily recognize that these buttons BN1, BN2, and BN3 are destinations for dropping in the drag-and-drop operation.

Then, the user UA drops the operation target file onto a button (one of the buttons BN1 to BN3) that corresponds to the desired action (one of the actions AC1 to AC3). In response to this drop operation, the corresponding action is executed.

For example, the operation of dropping the operation target file onto the instruction receiving button BN1 can realize the function corresponding to the function (copy and print output function) assigned to the hardware button 241 (i.e., the function of printing and outputting the operation target file).

The operation of dropping the operation target file onto the instruction receiving button BN2 can realize the function corresponding to the function (facsimile transmission function) assigned to the hardware button 243 (i.e., the function of transmitting the operation target file by facsimile).

The operation of dropping the operation target file onto the instruction receiving button BN3 can realize the function corresponding to the function (box storage function) assigned to the hardware button 245 (i.e., the box storage function of storing the operation target file in a box).

The following is a more detailed description of the case in which the display of the window as shown in FIG. 8 is started at a point in time immediately after the user UA has started a drag operation.

At time T1 (FIG. 4), the user UA starts a drag-and-drop operation (specifically, drag operation) of dragging and dropping the operation target file (here, file FL2) from among a plurality of files FLi (here, files FL1 to FL6) displayed on the touch screen 62 (see FIG. 7).

In response to the start of this drag operation, as shown in FIG. 8, the mobile terminal 60 starts movement processing for moving the display position of the operation target file FL2 (specifically, the corresponding icon) on the touch screen 62 (step S21). The mobile terminal 60 also transmits a notification indicating that the drag operation has started (start notification) to the MFP 10. In response to the start notification, the MFP 10 displays the buttons BN1 to BN3 on the touch screen 21 as shown in FIG. 8 (step S22). That is, the display of the instruction receiving buttons BN1 to BN3 is started.

The mobile terminal 60 also transmits icon information (e.g., icon image data) to the MFP 10 (step S23). After the transmission of the icon information has been completed, the mobile terminal 60 starts a transmission operation of transmitting information regarding the operation target file (e.g., file data) to the MFP 10. Since the volume of the information regarding the operation target file is relatively large and it thus takes relatively long time to transmit the information, the transmission operation is executed in parallel with the drag operation and will be complete at time T4 after the elapse of a predetermined amount of time. For this reason, it is preferable for the operation of transmitting the information regarding the operation target file to be started early before the drop operation of the drag-and-drop operation is complete (at a predetermined point in time before the drop operation is complete (in the present example, during the drag operation)). Doing so makes it possible to complete the file transmission earlier than in the case where the file transmission is started after completion of the drop operation.

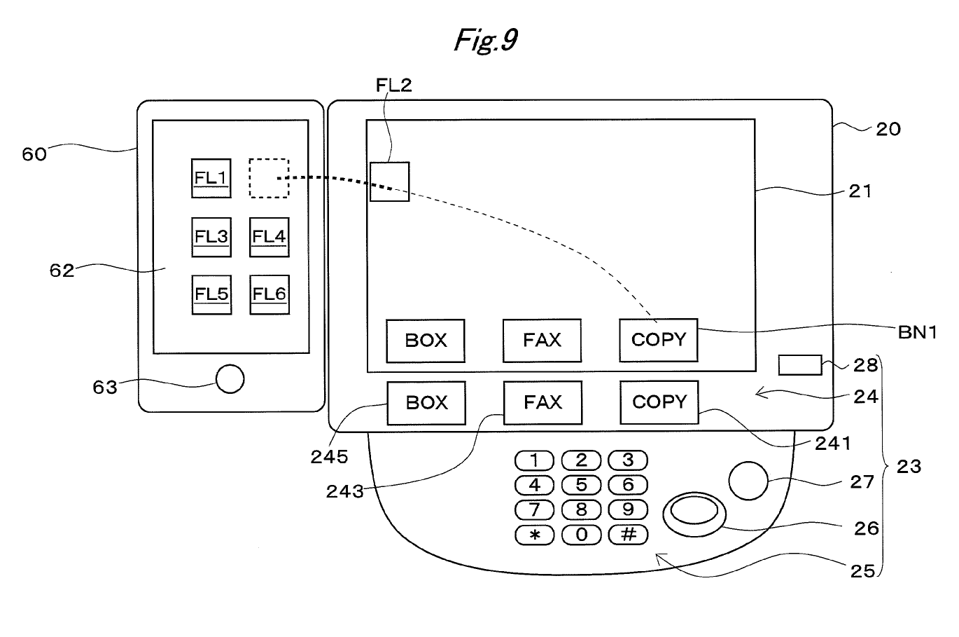

After that, when the icon of the operation target file crosses the boundary between the two devices 60 and 10 (specifically, the right edge of the touch screen 62) by the continuous drag operation by the user UA, the mobile terminal 60 transmits edge position information PE to the MFP 10 (step S25). This edge position information PE includes, for example, the display position of the icon (in particular, the longitudinal position (Y position)) displayed at the edge (+X-side edge (right-side edge)) of the touch screen 62. If a touch operation at the left-side edge of the touch screen 21 (specifically, the corresponding range in the longitudinal direction) has been detected thereafter, this touch operation is taken as part of the continuous drag operation based on the edge position information PE. Then, the MFP 10 displays an icon at the touched position at the left-side edge (−X-side edge) of the touch screen 21, based on the edge position information PE or the like (step S27). The mobile terminal 60, on the other hand, deletes the icon that was displayed at the right-side edge (+X-side edge) of the touch screen 62 (step S26). In this way, the display of the icon is carried over from the mobile terminal 60 to the MFP 10 in accordance with the drag operation by the user UA (see FIG. 9).

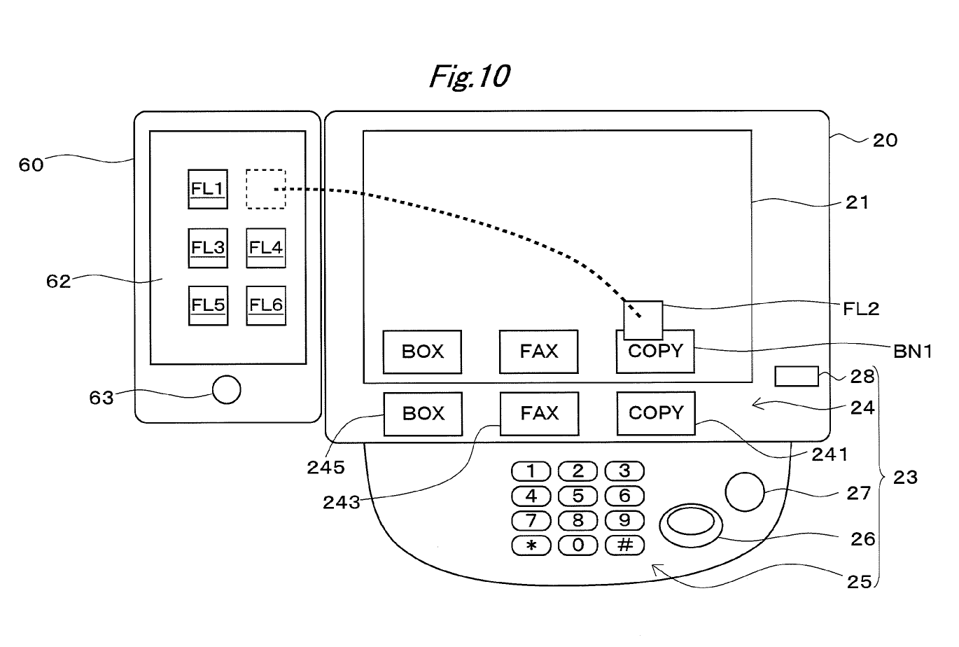

Thereafter, the user UA further continues the drag operation (this time, on the touch screen 21). Then, at time T6, the operation target file (specifically, the icon of the file) is dropped onto the desired drop destination (here, the “COPY” button BN1) as shown in FIG. 10. Accordingly, the drop operation is completed. This completes the drag-and-drop operation as shown in FIG. 11.

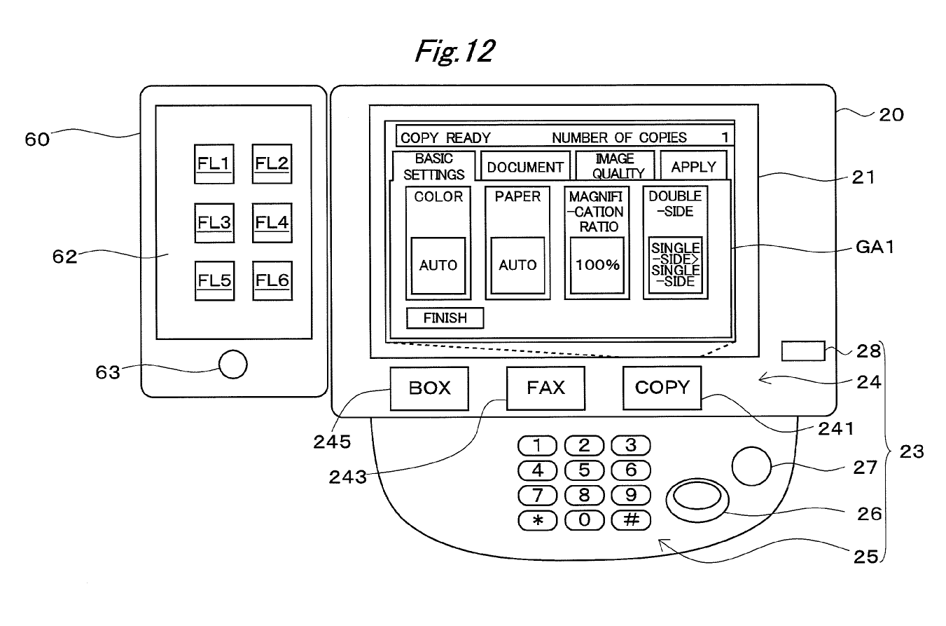

When the drop operation has been completed at time T6, in response to this completion of the drop operation, the MFP 10 displays an advanced settings window GA1 for execution of the action corresponding to the button BN1 on the touch screen 21 as shown in FIG. 12 (step S31). Note here that the display of the buttons BN1 to BN3 is removed with the start of display of the advanced settings window GA, and the advanced settings window GA1 is displayed in large size using the entire touch screen 21.

Then, the user UA performs various types of settings regarding the print output of the operation target file (e.g., settings such as “color/monochrome”, “paper size”, “magnification ratio”, and “single-side/double-side”) using this advanced settings window GA1, and presses the start button 26 when ending the setting operation.

In response to the pressing of the start button 26, the MFP 10 executes the action AC1 using, for example, the file data of the operation target file FL2 that was previously received at time T4. Specifically, the MFP 10 generates print output data based on the file data of the operation target file FL2 and executes the print output of the operation target file FL2 using the print output data. In this print output, the content of settings performed using the aforementioned advanced settings window GA1 is reflected.

Although the above description focuses on the drop operation of dropping the operation target file onto the button BN1, the same applies to the drop operations of dropping the operation target file onto the other buttons BN2 and BN3.

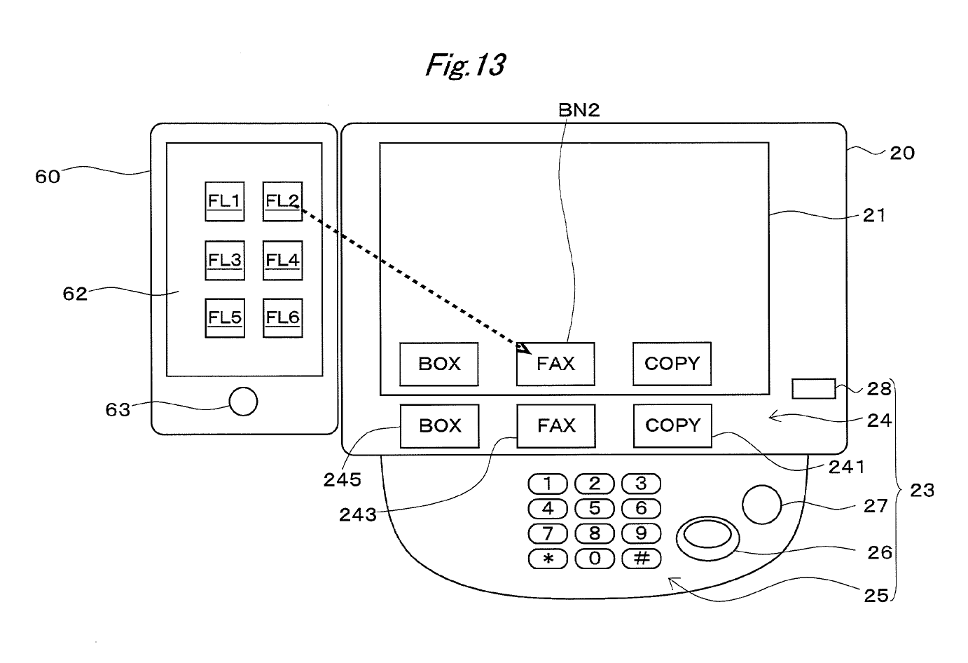

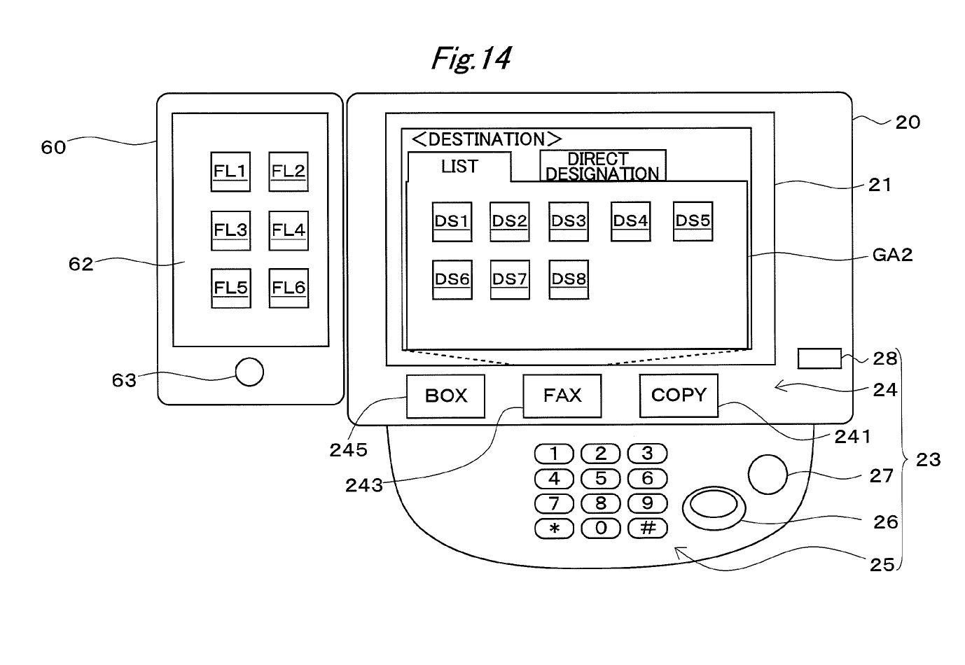

For example, when the operation target file (specifically, the icon of the file) is dropped onto the “FAX” button BN2 by a drag-and-drop operation as shown in FIG. 13, an advanced settings window GA2 for facsimile transmission is displayed as shown in FIG. 14. The advanced settings window GA2 displays a plurality of destinations DS1 to DS8 (specifically, buttons for the destinations). The user UA can designate a destination of facsimile transmission using the advanced settings window GA2. Specifically, the user UA can designate the transmission destination by pressing the desired destination button from among the plurality of destinations DS1 to DS8. Alternatively, the user UA may directly input a FAX number using a numeric keypad 25 or the like after pressing a direct designation tab in the advanced settings window GA2.

Thereafter, the action AC2 is executed in response to the pressing of the start button 26. Specifically, image data for facsimile transmission is generated by imaging each page of the operation target file and is then transmitted by facsimile to the designated destination.

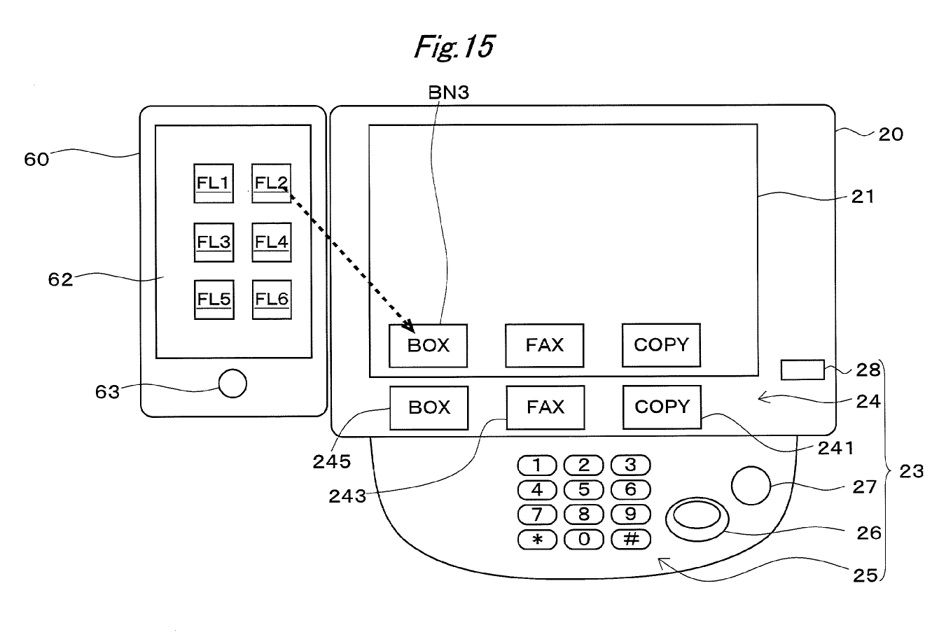

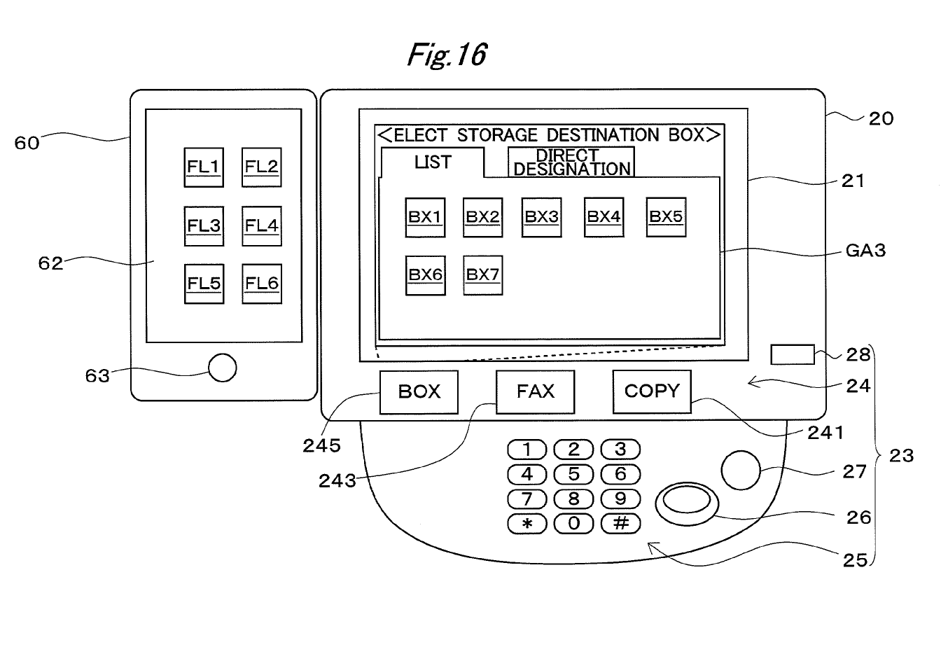

Likewise, when the operation target file (specifically, the icon of the file) is dropped onto the “BOX” button BN3 by a drag-and-drop operation as shown in FIG. 15, an advanced settings window GA3 for box storage processing is displayed as shown in FIG. 16. The advanced settings window GA3 displays a plurality of boxes BX1 to BX7 (specifically, buttons for the boxes). The user UA can designate a storage destination of the box storage processing (specifically, a storage destination box (folder)), using the advanced settings window GA3. Specifically, the user UA can designate a storage destination by pressing the button for the desired storage destination box from among the plurality of boxes BX1 to BX7. Thereafter, the action AC3 is executed in response to the pressing of the start button 26. Specifically, the operation target file is stored in the designated box (folder).

Note that when the icon of the operation target file is dropped onto an area that does not correspond to any of the buttons BN1 to BN3 in the touch screen 21 (i.e., invalid area as a drop destination), a warning window showing a message such as “Select the file again and redo the drag-and-drop operation” is displayed on the touch screen 21. The user UA who has confirmed the warning window re-executes the drag-and-drop operation. At this time, the buttons BN1 to BN3 may be temporarily removed or continuously displayed until the re-executed drag-and-drop operation is complete.

As described above, according to the present embodiment, information regarding the operation target file is transmitted from the mobile terminal 60 to the MFP 10 in accordance with a drag-and-drop operation across the touch screen 21 and the touch screen 62, and the MFP 10 executes an action regarding the operation target file based on the transmitted information. Accordingly, an action regarding the operation target file stored on the mobile terminal 60 side can be executed on the MFP 10 side. That is, files can be used across devices. Furthermore, an instruction to execute an action regarding the operation target file can be given in an intuitive and simple operation, i.e., “a drag-and-drop operation of dragging and dropping the operation target file (specifically, the icon of the file)”.

Moreover, the instruction receiving buttons BN1, BN2, and BN3 are displayed in the touch screen 21 at a predetermined point in time after the drag operation of a drag-and-drop operation is started (in the present example, a point in time immediately after the drag operation is started). In other words, the buttons BN1 to BN3 are appropriately displayed before the movement of the icon from the touch screen 62 to the touch screen 21 in the drag-and-drop operation is complete. Thus, a target (target area) for the drop operation is appropriately displayed, and the user UA can easily recognize a drop destination in the touch screen 21. In particular, since the display of the buttons BN1 to BN3 on the touch screen 21 is started at a point in time immediately after the drag operation is started on the touch screen 62, the user UA can easily recognize the buttons BN1 to BN3 as candidates for the drop destination.

The instruction receiving buttons BN1, BN2, and BN3 are respectively buttons for receiving instructions to execute actions that realize the functions corresponding to the hardware buttons 241, 243, and 245, and are respectively disposed in the vicinity of the hardware buttons 241, 243, and 245. It is thus possible to easily realize the functions corresponding to the functions assigned to the hardware buttons 241, 243, and 245 by the operation of dropping the operation target file onto the instruction receiving buttons BN1, BN2, and BN3. In particular, since the instruction receiving buttons BN1, BN2, and BN3 are respectively disposed in the vicinity of the hardware buttons 241, 243, and 245, the correspondence between the instruction receiving buttons BN1, BN2, and BN3 and the hardware buttons 241, 243, and 245 is easy to understand.

The touch screen 21 displays an advanced settings window GA (GA1, GA2, or GA3) regarding an action AC (AC1, AC2, or AC3) in response to the operation of dropping the operation target file onto an instruction receiving button BN (BN1, BN2, or BN3). Thus, advanced settings can be performed immediately after the drop operation, which achieves high operability.

Note that although the present example describes the case in which the advanced settings window GA is displayed in response to the drop operation, the present invention is not limited to this. For example, the advanced settings window GA3 (window showing a list of storage destinations) as shown in FIG. 16 may be displayed in response to the fact that a state in which the icon is overlaid on the “Box” button BN3 during the drag operation has continued for a fixed period of time (e.g., one second). After that, the user UA may continue the drag operation and drop the operation target file (specifically, the icon thereof) onto the desired storage destination folder in order to store the operation target file in that storage destination folder.

1-5. Operations in Opposite Direction

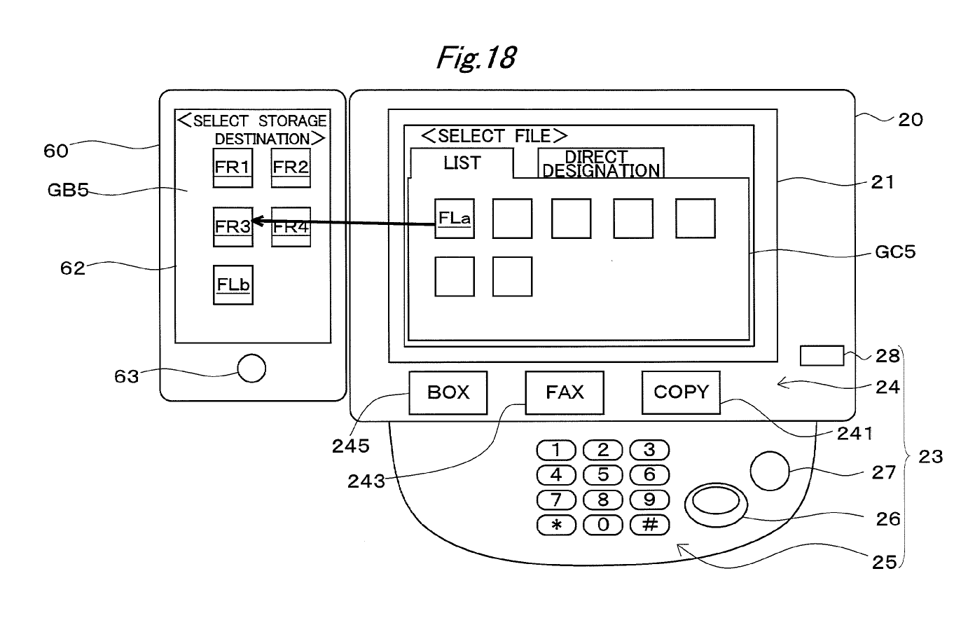

Although the case in which a drag-and-drop operation is executed from the mobile terminal 60 to the MFP 10 is described above, the present invention is not limited to this. Conversely, a drag-and-drop operation may be executed from the MFP 10 to the mobile terminal 60. In this case, basically, it is sufficient that the two apparatuses 10 and 60 appropriately execute operations opposite to the apparatuses shown in FIG. 4. Specifically, it is sufficient for the mobile terminal 60 to execute the operations executed by the MFP 10 in FIG. 4, and for the MFP 10 to execute the operations executed by the mobile terminal 60 in FIG. 4. The following describes such operations (specifically, a file copy operation for copying an operation target file stored in the MFP 10 in a storage unit of the mobile terminal 60). It is assumed here that a drag-and-drop operation from the MFP 10 to the mobile terminal 60 always causes a file copy operation to be executed. It is also assumed that in the mobile terminal 60, the operation in step S22 of displaying the buttons BN1 to BN3 is not performed, and instead, an operation of displaying an advanced settings window GB5 that displays storage destination folders is immediately performed. Specifically, in response to the start of a drag operation in the MFP 10, the advanced settings window GB5 (window showing a list of storage destinations) as shown in FIG. 18 is displayed on the touch screen 62.

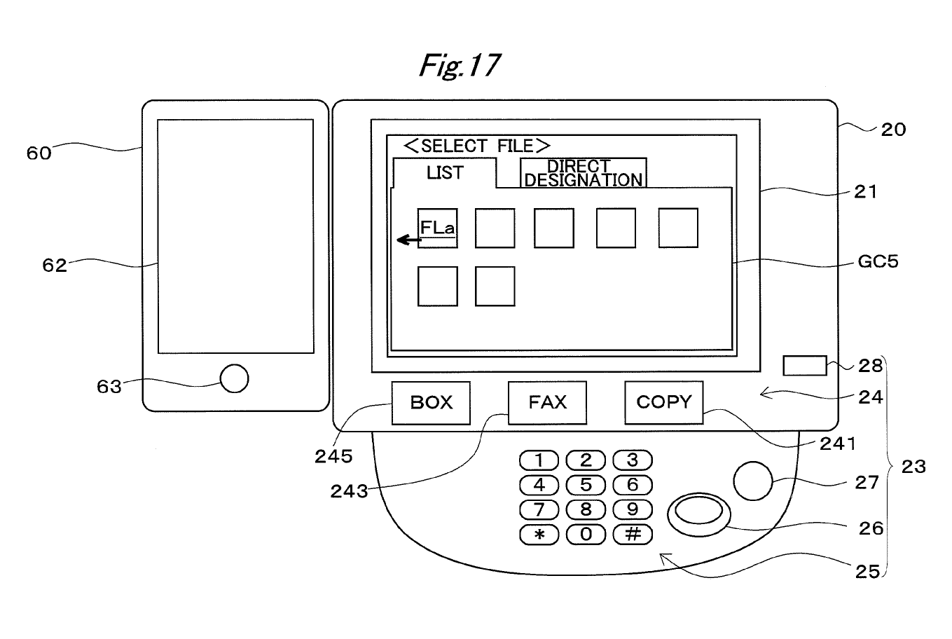

Specifically, as shown in FIG. 17, the user UA first performs a predetermined operation so as to cause an operation file selection screen GC5 to be displayed on the touch screen 21. This selection window GC5A displays a plurality of files (specifically, icons of the files). Next, the user UA selects a desired file FLa as the operation target file from the plurality of files and starts a drag-and-drop operation from the touch screen 21 to the touch screen 62.

When the drag operation is started in the MFP 10, the MFP 10 transmits a notification indicating the start of the drag operation to the mobile terminal 60. In response to the drag operation start notification, the mobile terminal 60 displays, on the touch screen 62, the advanced settings window GB5 (storage destination selection window or storage destination list window) that includes a plurality of candidates for the storage destination folder (see FIG. 18). For example, a window showing a list of data pieces stored in the mobile terminal 60 is displayed as the advanced settings window GB5.

The user UA continues the drag-and-drop operation from the touch screen 21 to the touch screen 62 and drops the operation target file FLa (specifically, the icon of the file) onto a desired storage destination folder FR3 (specifically, the icon of the folder) displayed on the touch screen 62. Accordingly, the operation target file FLa in the MFP 10 is stored in the storage destination folder FR3 in the mobile terminal 60.

As a result of such operations, information regarding the operation target file is transmitted from the MFP 10 to the mobile terminal 60 in accordance with the drag-and-drop operation across the touch screen 21 and the touch screen 62, and the mobile terminal 60 copies and stores the operation target file in the designated folder in the mobile terminal 60 based on the transmitted information. Accordingly, an action using a file stored on the MFP 10 side can be executed on the mobile terminal 60 side, which means that files can be used across the devices. In particular, the operation target file stored on the MFP 10 side can be easily copied to the mobile terminal 60 in a single drag-and drop operation.

### 2. Second Embodiment

A second embodiment is a variation of the first embodiment. The following description focuses on differences from the first embodiment.

The second embodiment describes a mode using execution histories of actions involved in coordinated operations with mobile terminals. In the second embodiment, execution histories of actions involved in a coordinated operation with a mobile terminal is stored in part (history storage unit) of the storage unit 5 of the MFP 10.

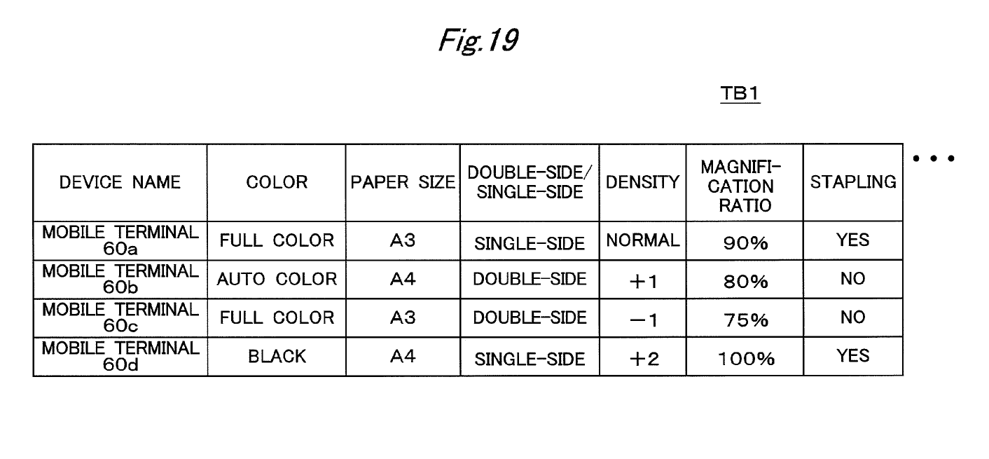

FIG. 19 shows a data table TB1 that stores execution histories of the action AC1. As shown in FIG. 19, this data table TB1 stores the latest execution histories of the action AC1 for a plurality of mobile terminals 60a to 60d. The execution histories store past settings information regarding the action AC1, and more specifically, “advanced settings” used in the latest execution (the content of various advanced settings including “color”, “paper size”, “double-side/single-side”, “density”, “magnification ratio”, and “the presence/absence of stapling”). For example, for the mobile terminal 60a, the content of settings stored (immediately previous settings) includes “full color”, “paper size=A3”, “single-side”, “normal density”, “magnification ratio of 90%”, “stapling=yes”.

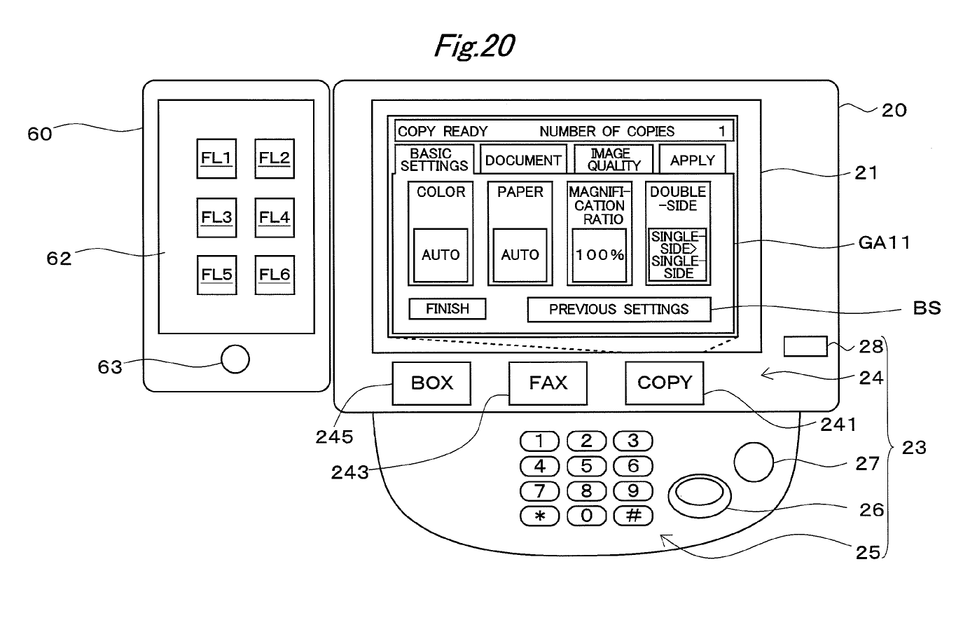

Then, the operations shown in FIG. 4 are executed as in the first embodiment, and the advanced settings window GA is displayed on the touch screen 21 upon completion of the drop operation of the drag-and-drop operation (step S31). At this time, the advanced settings window GA is provided with a button BS for instructing the use of “previous settings”. In FIG. 20, the button BS for instructing the use of “previous settings” is displayed in an advanced settings window GA11 regarding the action AC1. The user UA can easily set the content of the previous advanced settings by pressing the button BS and thus can easily use the past settings information.

In particular, the content of previous settings for the currently coordinating mobile terminal 60a from among a plurality of mobile terminals 60 (specifically, 60a, 60b, 60c, 60d, and so on) is set in response to the pressing of the button BS. Thus, the content of previous settings for each mobile terminal (by extension, for each user) can be easily set.

Note that the same applies to the other actions AC2 and AC3. In the action AC2, using a similar button BS enables the user UA to easily and reliably designate the same destination as the previous one as the current destination. In the action AC3, using a similar button BS enables the user UA to easily and reliably designate the same storage destination folder as the previous one as the current storage destination folder.

Although the present example mainly describes a mode using only settings information regarding the latest execution histories of the action AC1, the present invention is not limited to this. For example, a plurality of pieces of past settings information may be stored in the execution histories of the action AC1 (or AC2 or AC3), and one of the plurality of pieces of settings information may be used. To be more specific, a window showing such a plurality of pieces of past settings information in a list form or the like (list display window) may be displayed on the touch screen 21 in response to the pressing of the button BS or the like, and the desired settings may be selected and designated from the list display window.

### 3. Third Embodiment

A third embodiment is a variation of the first embodiment (or the second embodiment).

In the above-described embodiments, the instruction receiving buttons BN1 to BN3 are displayed on the touch screen 21 immediately after the drag operation of a drag-and-drop operation is started (step S22), but the present invention is not limited to this. Specifically, the instruction receiving buttons BN1 to BN3 may be displayed on the touch screen 21 when the operation target file (specifically, the icon of the file) is moved from the touch screen 62 to the touch screen 21 in the drag-and-drop operation.

Furthermore, although in the above-described embodiments, the operation of transmitting and receiving the operation target file is started immediately after the drag operation of the drag-and-drop operation is started (step S24), the present invention is not limited to this. Specifically, the operation of transmitting and receiving the operation target file may be started when the operation target file (specifically, the icon of the file) is moved from the touch screen 62 to the touch screen 21 in the drag-and-drop operation.

The third embodiment describes these modes, focusing on differences from the first embodiment.

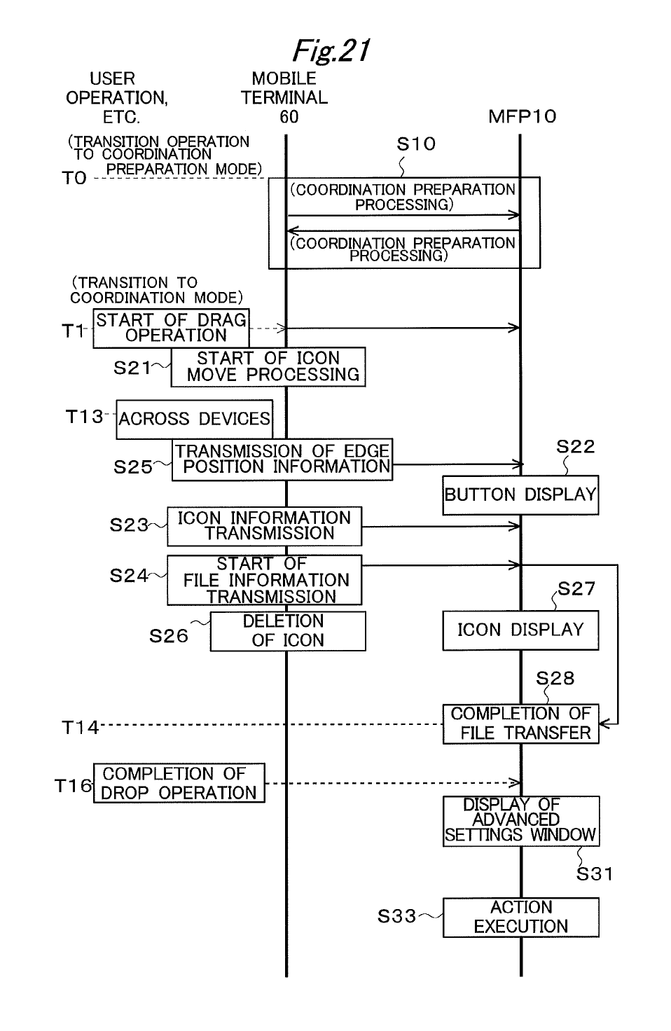

FIG. 21 shows operations according to the third embodiment.

As shown in FIG. 21, in the third embodiment like in the above-described first embodiment, the coordination preparation operation (step S10) is performed and then a drag operation is started at time T1. Note that in the third embodiment, unlike the first embodiment, the buttons BN1 to BN3 are not displayed at the time immediately after the start of the drag operation.

Thereafter, when the operation target file (specifically, an icon of the file) is moved from the touch screen 62 to the touch screen 21 in the drag-and-drop operation (in short, when the dragged position has crossed the boundary between the devices) (time T13), processing for transmitting the edge position information PE is performed (step S25), and the instruction receiving buttons BN1 to BN3 are displayed (step S22).

Also, the operation of transmitting icon information is performed (step S23), and the processing for transmitting file information is started (step S24). In this way, it is preferable for the transmission of the information regarding the operation target file to be started earlier before the drop operation of the drag-and-drop operation is complete (a predetermined point in time before the drop operation is complete (in the present example, when the dragged position has crossed the boundary between the devices)). Through this, the file transmission can be completed at an earlier stage (time T4) than in the case where the file transmission is started after the drop operation is completed.

Then, the processing for deleting the icon on the mobile terminal 60 side (step S26) and the operation of displaying the icon on the MFP 10 side (step S27) are executed. As a result, the display of the icon is carried over from the mobile terminal 60 to the MFP 10 in accordance with the drag operation by the user UA (see FIG. 9).

Thereafter, when the user UA has dropped the operation target file (specifically, the icon of the file) onto the desired drop destination (time T16), the advanced settings window GA for execution of an action corresponding to the drop destination is displayed on the touch screen 21 (step S31).

The user UA performs various settings using this advanced settings window GA, and when the start button 26 is pressed upon completion of the setting operation, the corresponding action is executed (step S33).

Even through the above-described operations, an effect similar to that of the above-described first embodiment can be achieved.

### 4. Variations

While the above has been a description of embodiments of the present invention, the present invention is not intended to be limited to the above-described examples.

For example, although the above-described embodiments describe the case in which the display of the buttons BN1 to BN3 on the touch screen 21 is removed along with the start of the display of the advanced settings window GA, the present invention is not limited to this. The display of the buttons BN1 to BN3 may be continued even during display of the advanced settings window GA.

Furthermore, although the above-described embodiments describe a mode in which nothing is displayed on the touch screen 21 at the time of switching to the “coordination mode”, the present invention is not limited to this. For example, a normal menu window or the like may be displayed at the time of switching to the coordination mode, and the buttons BN1 to BN3 may be displayed at a predetermined point in time after the drag operation is started, instead of (or in addition to) the menu window or the like. Alternatively, the buttons BN1 to BN3 may be displayed from the time of switching to the coordination mode.

The present invention may be embodied in various other forms without departing from the spirit or essential characteristics thereof. The embodiments disclosed in this application are to be considered in all respects as illustrative and not limiting. The scope of the invention is indicated by the appended claims rather than by the foregoing description, and all modifications or changes that come within the meaning and range of equivalency of the claims are intended to be embraced therein.

What is claimed is:

1. An image forming apparatus comprising:
an operation input unit having a first touch screen;
a reception unit configured to receive information regarding an operation target file from a mobile terminal in accordance with a drag-and-drop operation across the first touch screen and a second touch screen provided in the mobile terminal; and
an operation control unit configured to execute an action regarding the operation target file, based on the information regarding the operation target file received by the reception unit.

2. The image forming apparatus according to claim 1, wherein
the first touch screen displays a first instruction receiving button for receiving an instruction to execute the action, the first instruction receiving button being a target area for a drop operation of the drag-and-drop operation.

3. The image forming apparatus according to claim 2, wherein
the operation input unit includes a second instruction receiving button in the periphery of the first touch screen, the second instruction receiving button being a hardware button for receiving an instruction to execute a predetermined function, and
the first instruction receiving button is a button for receiving an instruction to execute the action that implements the function corresponding to the second instruction receiving button, and is disposed in the vicinity of the second instruction receiving button.

4. The image forming apparatus according to claim 2, wherein
the first touch screen displays an advanced settings window regarding the action, in response to the drop operation for dropping an icon regarding the operation target file onto the first instruction receiving button.

5. The image forming apparatus according to claim 4, further comprising:
a history storage unit configured to store an execution history of the action involved in a coordinated operation with the mobile terminal,
wherein the first touch screen displays, in the advanced settings window, a predetermined setting button for setting use of past settings information stored in the execution history of the action.

6. The image forming apparatus according to claim 2, wherein
the first touch screen displays the first instruction receiving button at a predetermined time after a drag operation of the drag-and-drop operation is started.

7. The image forming apparatus according to claim 6, wherein
the first touch screen displays the first instruction receiving button immediately after the drag operation of the drag-and-drop operation is started.

8. The image forming apparatus according to claim 6, wherein
the first touch screen displays the first instruction receiving button at a point in time when an icon regarding the operation target file is moved from the second touch screen to the first touch screen in the drag-and-drop operation.

9. The image forming apparatus according to claim 1, wherein
the reception unit starts an operation for receiving the operation target file at a predetermined point in time before a drop operation of the drag-and-drop operation is complete.

10. The image forming apparatus according to claim 1, wherein
the action includes a print output operation regarding the operation target file.

11. The image forming apparatus according to claim 1, wherein
the action includes a facsimile transmission operation regarding the operation target file.

12. The image forming apparatus according to claim 1, wherein
the action includes a storage operation for storing the operation target file in a storage unit of the image forming apparatus.

13. An image forming system comprising:
an image forming apparatus; and
a mobile terminal capable of coordination with the image forming apparatus,
the image forming apparatus comprising:
an operation input unit having a first touch screen;
a reception unit configured to receive information regarding an operation target file from a mobile terminal in accordance with a drag-and-drop operation across the first touch screen and a second touch screen provided in the mobile terminal; and
an operation control unit configured to execute an action regarding the operation target file, based on the information regarding the operation target file received by the reception unit.

14. An image forming system comprising:
an image forming apparatus; and
a mobile terminal capable of coordination with the image forming apparatus,
the image forming apparatus comprising:
an operation input unit having a first touch screen; and
a transmission unit configured to transmit information regarding an operation target file to the mobile terminal in accordance with a drag-and-drop operation across the first touch screen and a second touch screen provided in the mobile terminal, and
the mobile terminal comprising:
a reception unit configured to receive the information regarding the operation target file from the transmission unit of the image forming apparatus; and
an operation control unit configured to execute an action regarding the operation target file, based on the information regarding the operation target file received by the reception unit.

15. The image forming system according to claim 14, wherein
the action includes a storage operation for storing the operation target file in a storage unit of the mobile terminal.
